(19) United States
(12) Patent Application Publication
(10) Pub. No.: US 2006/0284876 A1
(43) Pub. Date: Dec. 21, 2006

(54) Method and apparatus for programming an input/output device over a serial bus

(76) Inventors: Yun Shon Low, Richmond (CA); Raymond Chow, Richmond (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/153,125

(22) Filed: Jun. 15, 2005

(51) Int. Cl. G06F 13/00

(52) U.S. Cl. 345/536

(57) ABSTRACT

A preferred embodiment is an apparatus for programming an input/output device over a serial bus that significantly reduces the burden placed on a host device associated with programming such devices. The preferred embodiment includes (a) a first memory for storing units of a programming sequence, each unit in the programming sequence having a command portion and a data portion; (b) a second memory having a single address; (c) a fetching circuit for transferring the programming sequence one unit at a time from the first memory to the second memory; and (d) a bus control circuit for translating the command portion of each said unit into a serial bus command for use with respect to the corresponding data portion.

### FIELD OF THE INVENTION

The present invention relates to graphics display systems, and more particularly to an efficient method and apparatus for programming an input/output device over a serial bus.

### BACKGROUND

Graphics display systems typically employ a graphics controller as an interface between a graphics display device and one or more image data sources. Commonly, in a graphics display system the image data sources are a host and a camera. The host and camera each transmit image data to the graphics controller, and the graphics controller then transmits the image data to the display device.

Generally, the graphics controller includes an internal memory for storing the image data it receives. Before transmitting the image data to the display, the graphics controller processes the image data. For example, the graphics controller may compress or decompress image data. In addition, the graphics controller may crop, resize, scale, and color convert the image data. In some systems, it is desirable to use the graphics controller to perform additional functions. For instance, the graphics controller may act as an interface with an input/output (“I/O”) device, such as the camera. In this arrangement, the graphics controller may be used to program or otherwise control the I/O device.

Using a graphics controller to program an I/O device imposes a certain amount of overhead on the host. This overhead may be acceptable in some cases, e.g., with relatively simple devices, but can be a significant burden on the host in other situations. For example, devices requiring elaborate programming sequences or systems provided with multiple I/O devices. Because the host in a mobile communications device is typically heavily loaded with other processing tasks, such as those related to baseband and communications, it would be desirable to minimize the burden on the host.

In addition, in battery-powered portable graphics display systems, however, there is an ever present need to minimize power consumption. Further, there is also a need to minimize the size of the graphics controller integrated circuit (“IC”). A graphics controller capable of taking advantage of an efficient method or including an efficient apparatus for programming an input/output device over a serial bus would be desirable to help achieve these goals.

Accordingly, an efficient method and apparatus for programming an input/output device over a serial bus which minimize the burden on a host is needed.

### SUMMARY

One preferred embodiment is an apparatus for programming an input/output device over a serial bus that reduces the burden placed on a host device associated with programming such devices. A preferred embodiment includes (a) a first memory for storing units of a programming sequence, each unit in the programming sequence having a command portion and a data portion; (b) a second memory having a single address; (c) a fetching circuit for transferring the programming sequence one unit at a time from the first memory to the second memory; and (d) a bus control circuit for translating the command portion of each unit into a serial bus command for use with respect to the corresponding data portion.

Another embodiment is directed to a method for programming a device over a serial bus. A preferred embodiment comprises the steps of: (a) reading a programming sequence from a first memory one unit at a time, each unit having a command portion and a data portion; (b) writing each unit to a second memory at a single address; and (c) translating the command portion of each unit into a serial bus command for use with respect to the corresponding data portion.

An further embodiment is directed to a graphics display system comprising: (a) a host; (b) an input/output device; (c) a first memory for storing units of a programming sequence, each unit having a command portion and a data portion; (d) a fetching circuit for transferring the programming sequence one unit at a time from first memory to a second memory at a single address; and (e) a bus control circuit for translating the command portion of each unit into a serial bus command for use with respect to the corresponding data portion.

In yet another embodiment, a medium readable by a machine is disclosed. The medium embodies a program of instructions pertaining to a method for programming a device over a serial bus. The method comprises the steps of: (a) reading a programming sequence from a first memory one unit at a time, each unit having a command portion and a data portion; (b) writing each unit to a second memory at a single address; and (c) translating the command portion of each unit into a serial bus command for use with respect to the corresponding data portion.

This summary does not disclose all embodiments of the invention, nor does it disclose all features and aspects of the invention. The embodiments, features, and aspects described in this summary, and other embodiments, features, and aspects of the invention will be apparent upon consideration of the following detailed description.

### BRIEF DESCRIPTION OF THE DRAWINGS

FIG. 1 is a block diagram of a graphics display system which includes a graphics controller and a memory illustrating one exemplary context for the invention.

FIG. 2 is a block diagram of a graphics controller according to one preferred embodiment of the invention suitable for use in the system of FIG. 1.

FIG. 3 is a block diagram of the memory of FIG. 1 showing a storage arrangement for a camera programming sequence according to a preferred embodiment.

### DETAILED DESCRIPTION

In a preferred embodiment, the invention is directed to a graphics controller for an efficient method and apparatus for programming an input/output device over a serial bus. The invention is also directed to a system and machine-readable medium providing an efficient method and apparatus for programming an input/output device over a serial bus. Reference will now be made in detail to preferred embodiments of the invention, examples of which are illustrated in the accompanying drawings. Wherever possible, the same reference numbers are used in the drawings and the description to refer to the same or like parts.

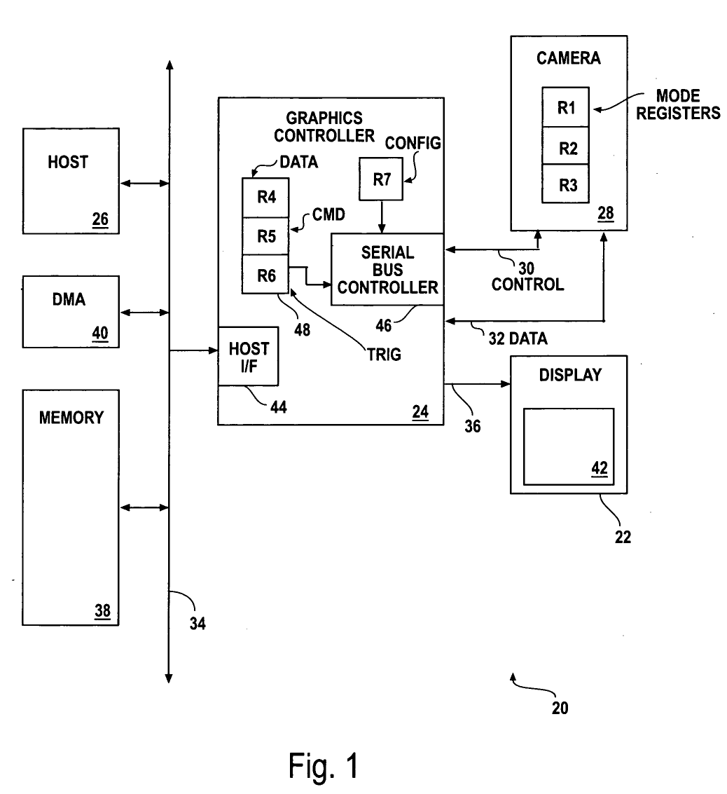

FIG. 1 depicts a graphics display system 20 illustrating one exemplary context for the invention. The system 20 includes a display device 22, a graphics controller 24, a host 26, and an image capture device 28. The system 20 may be any digital system or appliance providing graphics output. Preferably, the system 20 is a battery powered (not shown) portable appliance, such as a mobile telephone. FIG. 1 shows only those aspects of the system 20 believed to be helpful for understanding the invention, numerous other aspects having been omitted.

The host 26 is preferably a CPU or digital signal processor. The invention, however, is not limited to any particular type of host device. Any type of device that can function as a host or master is contemplated as being within the scope of the invention.

The image capture device 28 is preferably a camera module (“camera”). The camera typically includes registers (“mode registers”) that are used to define various operational modes of the camera. In an exemplary embodiment, the camera includes three mode registers R1, R2, and R3. The invention, however, is not limited to cameras; any type of I/O device having any number of mode registers is contemplated. For instance, alternatively the I/O device may be a flash memory card controller, a disk drive memory controller, or a CD ROM controller. Further, although in this description, preferred embodiments and examples are described with reference to a single camera, it should be understood that the invention may be used with any number of I/O devices.

The system 20 preferably includes a camera control bus 30, a camera data bus 32, a host bus 34, and a display bus 36. Preferably, the control bus 30 is a serial bus. In one embodiment, the control bus 30 is an Inter-Integrated Circuit (“I²C”) bus. The I²C is a 2 (or 3) wire bus including at least clock and data lines. In other embodiments, the control bus 30 may be a serial bus defined by a standard other than I²C, such as a proprietary protocol or the Universal Serial Bus (“USB”) standard. The camera control bus 30 is used for programming the camera. It is also used for reading the contents of camera registers and for other purposes. The camera data bus 32 is primarily used for transferring image data from the camera to the graphics controller. Preferably, the camera bus 32, the host bus 34, the display bus 36 are parallel, n-bit wide busses. For example, n=8. (Each bus may have a different width n.) The camera control bus 30 and camera data bus 32 couple the camera 28 (or cameras) to the graphics controller 24. The host bus 34 couples the host 26 to the graphics controller. The host bus 34 may be used for transferring data between devices coupled to the bus, such as the host and graphics controller. The display bus 36 is used for transferring image data and control signals to the display device 22. The buses described in this specification are preferably fixed electrically conductive traces known in the art. However, it should be appreciated that the described buses may also be wireless or optical.

The system 20 also includes a memory 38, and a direct memory access (“DMA”) controller 40, both of which are coupled to the host bus 34. The exemplary memory 38 is preferably a DRAM, though other types of memory technology may be used in the system 20. The host 26 may write data to or read data from the memory 38 via the bus 34. In addition, host 26 may access the graphics controller 24 and the DMA controller 40 via the bus 34. While the memory 38 and the DMA controller 40 are shown and referred to as separate from the host 26, this is not essential. In alternative embodiments, the host 26 may include the memory 38, or the DMA controller 40, or both. Similarly, the graphics controller 24 (or any other device, block, module, or component) may include the memory 38, or the DMA controller 40, or both.

The DMA controller 40 may be programmed to perform data transfers to and from the memory 38. Using the DMA controller 40, data may be transferred from the memory 38 to a device coupled to the bus 34, from a device to the memory, or from one location in the memory 38 to another location. Once the DMA controller 40 is programmed, no further involvement by the host is required. To program the DMA controller, a start memory address and the number of transfers (“burst length”) are written to the DMA controller. The DMA controller then generates the control and address signals for a series of data transfers. The address signals begin with the specified start address and increase sequentially until the specified maximum number of transfers is reached. While the DMA controller 40 is capable of addressing a single address repeatedly or a block of addresses sequentially, it is not able to “jump” around to a variety of non-sequential addresses. Upon completing the transfer, the DMA controller generates a signal indicating that the task has been completed. Any device comprised of hardware, firmware, software or a combination of these three types of components having the described DMA capabilities may be be referred to herein as a “fetching circuit.”

The display device 22 includes a display screen 42. The display device 22 is preferably a liquid crystal display (“LCD”), but may be any device capable of rendering image data, including CRT, plasma, and OLED display devices, as well as hard copy rendering devices, such as laser and inkjet printers. The system 20 may include two or more display devices.

The graphics controller 24 includes a host interface (“Host I/F”) 44 and a serial bus controller 46. The host interface 44 enables the graphics controller to communicate on the bus 34 in conformity with the required bus protocol. The serial bus controller 46 provides a mechanism for the graphics controller 24 to communicate with one or more devices coupled to the serial bus 30. (While additional devices are not shown in the figure, it is contemplated that additional devices may be coupled to the bus 30.) In order to conserve power and space in the graphics controller, the serial bus controller 46 is typically a low-level module. As such, the serial bus controller 46 performs basic functions, but lacks features found in bus controllers used in systems where power and conservation of integrated circuit space are less critical. For this reason, the serial bus controller 46 can impose significantly more processing overhead on the host than may be experienced with high-level bus controllers.

In the camera (or other I/O device), a significant number of parameters may be programmable and the host 26 uses the graphics controller 24 to program the camera 28. While the nature of these device parameters is not important to the invention, it may be helpful to note one example: the camera may be programmed to output frames of image data in different resolutions, the resolution being specified by one or more device parameters. The host specifies device parameters for the camera by first transmitting them to the graphics controller over the bus 34. The graphics controller then forwards the device parameters on to the camera over the bus 30. More particularly, the host 26 uses the graphics controller 24 to program the camera 28 as follows:

First, the host configures the serial bus controller 46 for bus access. To configure the serial bus controller, the host writes various transfer-related parameters to a configuration register (or registers) R7 in the graphics controller 24. Examples of transfer-related parameters include arguments for setting the transfer speed (serial bus clock rate), enabling the serial bus port, and enabling a serial bus interrupt. These specific transfer-related parameters will depend on, among other things, the particular bus employed, i.e., I²C or some other bus protocol.

Second, the host preloads a bus command (e.g., read/write) and data to the graphics controller 24. The exemplary graphics controller 24 includes a register R4 for the data (typically a byte), and a register R5 for the bus command, such as start, stop, read, and write (also typically a byte). The “data” that is preloaded typically corresponds to a particular device parameter or mode register address.

Finally, the host writes a bit to a register to trigger the bus access. A register R6 is provided for the trigger bit.

It should be noted that each register in the graphics controller has a unique address. When the host writes commands, data, or a trigger bit over the bus 34 for storage in the registers R4-R7, the host specifies a particular one of these register addresses.

After it has been programmed by the camera 28, the serial bus controller 46 translates each bus command stored in the registers 48 into corresponding electrical signals on the bus 30. For instance, in one bus protocol a start signal is signified by a high-to-low transition on a data line of the bus 30 while a bus clock line is held high.

Write (and read) transmission cycles typically have several phases. To write to a single register in the camera 28, three phases or bus transactions are typically required. An exemplary write transmission cycle includes three phases:

In a first phase, a 7 bit I/O address and a 1 bit write command are transmitted on the bus 30.

In a second phase, a 1 byte register address, e.g., the address of one of the registers R1, R2, or R3 in the camera, is transmitted on the bus 30.

And in a third phase, 1 byte of write data is transmitted on the bus 30.

In order to send a single command to the camera 28, it is typically necessary to write parameters to all three of the camera registers R1, R2, and R3 of the exemplary camera 20. Thus, a total of nine transactions on the serial bus 30 are required for each command the host wants to send to the camera.

As described above, when the host 26 uses the graphics controller 24 to program the camera 28, in one step the host preloads registers in the graphics controller with a bus command and data. As mentioned, the bus command may be a start, stop, read, write, or other command. In addition, the pre-loaded data corresponds to a particular device parameter or mode register address. The phrase “programming sequence” is used herein to refer to these bus commands and device parameter and register address data that must be written to the serial bus controller in order to cause it to program the camera or other device's mode registers.

The overhead associated with programming the camera using the serial bus controller 46 in the graphics controller can be a significant burden on the host 26. With respect to cameras with relatively simple programming sequences, the overhead may be acceptable. Cameras used in mobile devices, however, are becoming more and more sophisticated, requiring more elaborate programming sequences, which in turn requires the host to write larger and larger numbers of parameters to the camera registers. Further, mobile systems are being provided with multiple I/O devices. For instance, it is not uncommon for a mobile telephone to be provided with 2 cameras, each requiring programming by the graphics controller over the control bus 30. Accordingly, host programming of the camera using the serial bus controller is often a significant burden on the host.

Because the host in a mobile communications device is typically heavily loaded with other processing tasks, such as those related to baseband and communications, it would be desirable to offload the task of programming the serial bus controller. This need is felt especially in mobile system with I/O devices requiring elaborate programming sequences or having multiple I/O devices.

Offloading this task to a DMA controller to solve this problem is an approach that would not be obvious to one skilled in the art. The reason is that such an approach would entail repeatedly programming the DMA controller to fetch one bus device parameter from a memory and write it to the register R4 at a first address and to fetch one bus command from the memory and write it to the register R5 at the next sequential address. A host would need to repeat this sequence for each device parameter. Plainly, one skilled in the art would not consider using a DMA controller for a “burst” of only two transfers.

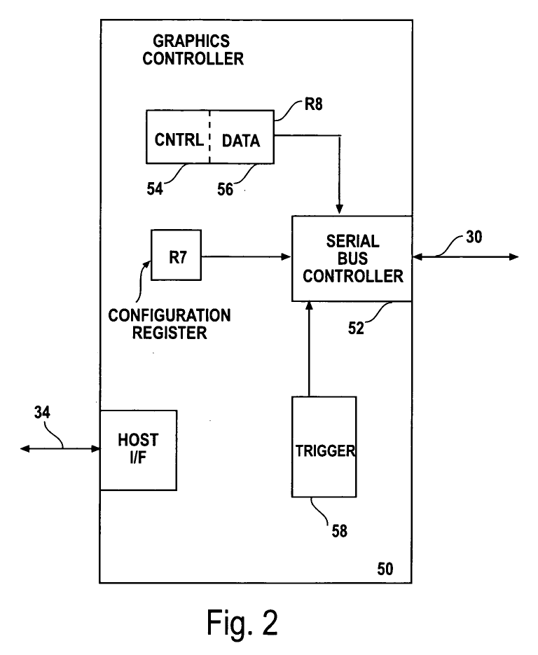

A graphics controller 50 having a serial bus controller 52 according to one embodiment of the invention is shown in FIG. 2. The graphics controller 50 is suitable for use in a graphics display system, such as the exemplary system 20, though its use is not limited to this system. The graphics controller 50 includes one register R8, a configuration register (or registers) R7, and a trigger circuit 58. The register R8 is preferably a 16-bit register, in which a lower byte 54 is for control bits and an upper byte 56 is for data. However, the size of the register R8 is not critical. In alternative embodiments, the register R8 may be provided in other sizes. In addition, the lower portion of the register may be used for data rather than control bits, just as upper portion of the register may be used for control instead of data bits. Further, while the control and data portions of the register are preferably one byte, each may be provided in sizes other than one byte if desired.

In operation, the host 26 stores a desired device programming sequence in the memory 38. In addition, the host 26 configures the serial bus controller 52 for access to the control bus 30. Further, the host 26 programs the DMA controller 40 to transfer the device programming sequence stored in memory to the register R8. With these actions, the involvement of the host 26 is complete.

Preferably, the camera programming sequence stored by the host is one of a plurality of such sequences for placing the camera in one of a corresponding number of modes. But this is not essential. All that is required is that there be at least one such device programming sequence. Further, while it is contemplated that the host will store a desired device programming sequence in the memory, this too is not essential. In alternative embodiments, the device programming sequence (or sequences) may be pre-stored in the memory. In one alternative embodiment, the device programming sequence is stored in pre-programmed read only memory, such as an EEPROM.

Once the serial bus controller is configured and the DMA controller programmed, the host 26 can resume other processing tasks without interruption. The DMA controller begins transferring the device programming sequence from the memory 38 to the register R8, preferably a word at a time. The trigger circuit 58 monitors the data transfer activity. Each time the DMA controller transfers a word from the memory to register R8, the trigger circuit 58 causes the serial bus controller 52 to transmit the command and data over the bus 30 for storage in one of the exemplary registers R1, R2, or R3 in the camera 28.

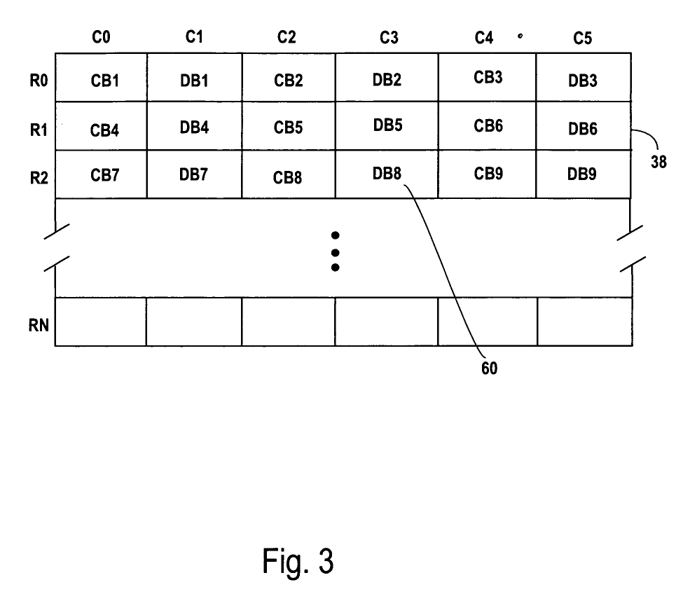

FIG. 3 shows the memory 38, and how a camera programming sequence is preferably stored in the memory 38. It should be understood that the memory 38 is a simplified memory for purposes of illustration. The invention may be practiced with any suitable memory with addressable memory locations. The exemplary memory 38 has 6 columns and N rows, the intersection of each row and column defining one of a plurality of one byte storage locations. In this example, the memory addresses are defined by a column and row number pair. For example, the memory address 60 is defined as column 3, row 2 or (C3, R2). In FIG. 3, control information is represented as CB1 (for command byte 1), CB2, CB3, etc. and data is represented as DB1 (for data byte 1), DB2, DB3, etc. For example, DB8 is stored at address 60 (C3, R2). As can be seen from the figure, the host stores command and data in alternate sequential memory address. For instance, CB1 is stored at address (C0, R0), DB1 is stored at address (C1, R0), CB2 is stored at address (C2, R0), DB2 is stored at address (C3, R0), and so on.

While the device programming sequence comprises at least on pair of command and data bytes forming a single word, and preferably many such pairs, the invention is not limited to command and data portions having any particular length. For instance, the command portion might be 4 bits and the data portion 1 byte. Many other combinations are possible. It should be recognized that sometimes a data portion may not be appropriate for use with a particular command. In these circumstance, the data byte may still be included in the camera programming sequence, taking, for example, a zero or null value.

The arrangement of command and data portions in the memory 38, as illustrated in FIG. 3, permits “burst” accesses. The host can perform a burst write operation when it stores the camera programming sequence in the memory 38. The DMA controller can perform a burst read operation when it reads a camera programming sequence from memory. The efficiency advantages of accessing memory using burst operations is well known in the art and for this reason will not be further described. It should be understood that the invention is not limited to the particular memory arrangement shown in FIG. 3; any arrangement permitting burst access may be employed.

Referring to FIGS. 2 and 3, when the host 26 programs the DMA controller 40, it specifies a starting memory address, a burst length, and an address for the register R8. In the simplified example of FIG. 3, the host would specify (C0, R0) as the starting memory address. When the DMA controller begins data (word) transfers, it first fetches CB1 from address (C0, R0) and DB1 from address (C1, R0). The DMA controller stores CB1 in the lower byte 54 and DB1 in the upper byte 56. Once the transfer is complete, the trigger circuit 58 causes the serial bus controller 52 to perform the bus command represented by CB1 with respect to DB1. That is, sending DB1 over the bus 30 to the camera 28. As operation of the DMA controller continues, it fetches from sequentially increasing addresses in the memory, but writes to the same address of the graphics controller register R8 each time. For example, the DMA controller would next fetch CB2 from address (C2, R0) and DB2 from address (C3, R0) for writing to the address of the register R8.

As mentioned above, the register R8 may be provided in various sizes in alternative embodiments. In the shown and described embodiment, the register R8 is of a size sufficient for storing exactly one command byte-data byte pair. For convenience, the command portion-data portion pair may also be referred to herein as a “unit.” In alternative embodiments, the register R8 may be provided with a capacity for storing two or more units. These alternatives would be beneficial, for example, where the DMA controller is capable of transfers of more than two bytes at a time.

It should now be apparent that the use of the single address register R8 permits the use of the DMA controller 48 to efficiently program the camera. Both the CPU and the DMA controller are able to employ burst access methods when programming the camera. Moreover, the burden on the host 26 to program the camera is significantly reduced when the principles of the invention are employed.

The inventors have recognized that this improved efficiency may create a problem in one circumstance, however, and accordingly have identified a solution to prevent such a problem. This circumstance may arise where the camera has an upper limit at which it is capable of receiving or otherwise processing a camera programming sequence. The DMA controller 38, the memory 40, and the graphics controller 50 may be capable of transferring programming parameters at rates which exceed the camera's ability to receive those parameters. The inventors have recognized that when the host configures the serial bus controller 52 for bus access, it should preferably specify a serial bus transfer speed that does not cause the camera to be overrun with data. Alternatively, buffers may be provided to prevent an overrun condition. Preferably, internal buffers are provided in the camera.

The invention has been described with reference to a DMA controller. It should be understood that any device with the capability to perform the described DMA functions may be substituted.

While the invention has been described with reference to an integrated circuit embodiment, the invention is also directed to a method for programming an input/output device over a serial bus. In one embodiment, the method includes at least the steps of: (a) reading a device programming sequence from the memory 38 in units having a command portion and a data portion; (b) writing the units to the register R8; and (c) translating the command portion of each unit into a serial bus command for use with respect to the corresponding data portion.

In addition, invention is directed to a machine readable medium, such as magnetic or optical disks, hard disk drives, memory chips of any type, and other similar memory devices. The medium embodies a program of instructions that may be executed by a machine, such as a computer system. The program of instructions may be software, firmware, hardware code, or other similar program. When the machine executes the program, it performs a method for programming an input/output device over a serial bus.

The terms and expressions that have been employed in the foregoing specification are used as terms of description and not of limitation, and are not intended to exclude equivalents of the features shown and described or portions of them. The scope of the invention is defined and limited only by the claims that follow.

We claim:

1. An apparatus for programming a device over a serial bus, comprising:
a first memory for storing units of a programming sequence, each unit having a command portion and a data portion;
a second memory having a single address; and
a fetching circuit for transferring said programming sequence one unit at a time from said first memory to said second memory; and
a bus control circuit for translating the command portion of each said unit into a serial bus command for use with respect to the corresponding data portion.

2. The apparatus of claim 1, further comprising a trigger circuit for activating the translation function of said bus control circuit.

3. The apparatus of claim 1, further comprising a third memory for storing bus configuration data.

4. The apparatus of claim 1, wherein said second memory is sized for storing one unit.

5. The apparatus of claim 4, wherein said units are words, said command portion is one byte and said data portion is one byte.

6. The apparatus of claim 1, wherein said second memory is sized for storing at least two units.

7. The apparatus of claim 1, wherein the second memory is in a graphics controller.

8. The apparatus of claim 1, wherein the device is a camera.

9. A method for programming a device over a serial bus, comprising the steps of:
reading a programming sequence from a first memory one unit at a time, each unit having a command portion and a data portion;
writing each said unit to a second memory at a single address; and
translating the command portion of each said unit into a serial bus command for use with respect to the corresponding data portion.

10. The method of claim 9, further comprising a step of configuring a serial bus controller for bus access.

11. The method of claim 10, wherein said step of configuring a serial bus controller includes setting a bus transfer speed which prevents data overrun in the device.

12. The method of claim 9, further comprising a step of storing said programming sequence in said first memory.

13. The method of claim 9, wherein said second memory is sized for storing one unit.

14. The method of claim 13, wherein said units are words, said command portion is one byte, and said data portion is one byte.

15. A graphics display system, comprising:
a host;
an input/output device;
a first memory for storing units of a programming sequence, each unit having a command portion and a data portion;
a fetching circuit for transferring said programming sequence one unit at a time from said first memory to a second memory at a single address; and
a bus control circuit for translating the command portion of each said unit into a serial bus command for use with respect to the corresponding data portion.

16. The system of claim 15, further comprising a trigger circuit for activating the translation function of said bus control circuit.

17. The system of claim 15, further comprising a third memory for storing bus configuration data.

18. The system of claim 15, wherein said second memory is sized for storing one unit.

19. The system of claim 15, further comprising a buffer for preventing data overrun in the input/output device.

20. The system of claim 15, wherein the input/output device is a camera.
